(19) United States
(12) Patent Application Publication
(10) Pub. No.: US 2013/0317873 A1
(43) Pub. Date: Nov. 28, 2013

(54) MEETING ATTENDANCE PLANNER

(71) Applicants: James R. Kozloski, New Fairfield, CT (US); Clifford A. Pickover, Yorktown Heights, NY (US); Robert W. Wisniewski, Ossining, NY (US)

(72) Inventors: James R. Kozloski, New Fairfield, CT (US); Clifford A. Pickover, Yorktown Heights, NY (US); Robert W. Wisniewski, Ossining, NY (US)

(73) Assignee: International Business Machines Corporation, Armonk, NY (US)

(21) Appl. No.: 13/478,101

(22) Filed: May 22, 2012

(51) Int. Cl. G06Q 10/10

(52) U.S. Cl. 705/7.19

(57) ABSTRACT

A system and method for planning meeting attendance. The method includes receiving from a meeting requestor a request to schedule a proposed meeting at a time interval. The method also includes automatically calculating by a computer processor an attendance probability value for a potential attendee based, at least in part, on the potential attendee's location over time. The method further includes marking an electronic calendar of the meeting requestor with an indicia of the attendance probability value for the potential attendee. Additionally, the method may include automatically scheduling the proposed meeting if the attendance probability value is beyond an attendance probability threshold.

### BACKGROUND

This invention relates to scheduling meetings, and more particularly to planning meeting attendance.

In traditional electronic calendars, meeting invitees sometimes accept invitations to meetings that they do not actually attend. This creates uncertainty regarding which invitees will actually attend a given meeting, even after these invitees have accepted invitations to the meeting.

### BRIEF SUMMARY

Accordingly, one example aspect of the present invention is a method for planning meeting attendance. The method includes receiving from a meeting requestor a request to schedule a proposed meeting at a time interval. The method also includes calculating an attendance probability value for a potential attendee based, at least in part, on the potential attendee's location over time. The method further includes marking an electronic calendar of the meeting requestor with an indicia of the attendance probability value for the potential attendee. Additionally, the method may include automatically scheduling the proposed meeting if the attendance probability value is beyond an attendance probability threshold.

Another example of the present invention is a system for planning meeting attendance. The system includes a computer processor configured to receive from a meeting requestor a request to schedule a proposed meeting at a time interval. The computer processor is further configured to calculate an attendance probability value for a potential attendee based, at least in part, on the potential attendee's location over time. Additionally, the computer processor is configured to mark an electronic calendar of the meeting requestor with an indicia of the attendance probability value for the potential attendee. The computer processor may also be configured to automatically schedule the proposed meeting if the attendance probability value is beyond an attendance probability threshold.

Yet another example of the present invention is a computer readable medium encoding instructions for performing a method for planning meeting attendance. The instructions include receiving from a meeting requestor a request to schedule a proposed meeting at a time interval. The instructions also include calculating an attendance probability value for a potential attendee based, at least in part, on the potential attendee's location over time. The instructions further include marking an electronic calendar of the meeting requestor with an indicia of the attendance probability value for the potential attendee. Additionally, the instructions may include automatically scheduling the proposed meeting if the attendance probability value is beyond an attendance probability threshold.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 shows a method for planning meeting attendance in accordance with one embodiment of the invention.

FIG. 2 shows a method for calculating the attendance probability value according to one embodiment of the present invention.

FIG. 3 shows a system for planning meeting attendance in accordance with one embodiment of the present invention.

FIG. 4 shows a computer-readable medium encoding instructions for performing a method for planning meeting attendance.

### DETAILED DESCRIPTION

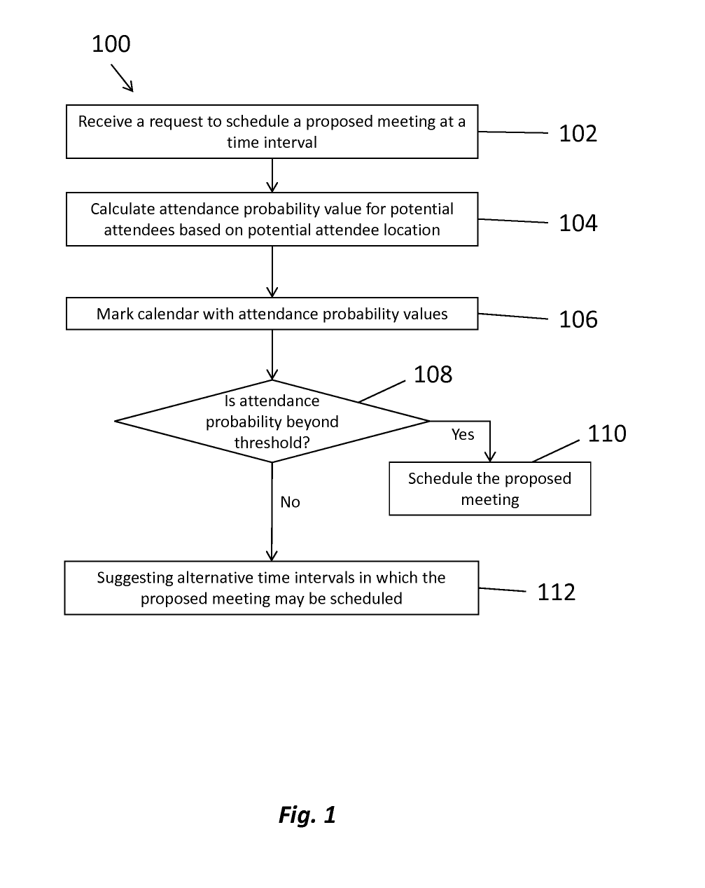

The present invention is described with reference to embodiments of the invention. Throughout the description of the invention reference is made to FIGS. 1-4. When referring to the figures, like structures and elements shown throughout are indicated with like reference numerals.

FIG. 1 shows a method for planning meeting attendance according to one embodiment of the present invention. The method includes a receiving step 102. During receiving step 102, a request is received from a meeting requestor to schedule a proposed meeting at a time interval. After receiving step 102 is completed, the method continues to attendance probability value calculation step 104.

At attendance probability value calculation step 104, an attendance probability value for a potential attendee based, at least in part, on the potential attendee's location over time is calculated. It is contemplated that the attendance probability value may further be based on, for example, the potential attendee's history of meeting attendance, the number of meetings scheduled on a calendar of the potential attendee on the day of the proposed meeting, a real-time location of the potential attendee prior to the time interval of the proposed meeting, a weather and/or traffic forecast at the real-time location of the potential attendee, and a crowd-sourced potential attendee applicant meeting attendance rating. After attendance probability value calculation step 104 is completed, the method continues to marking step 106.

At marking step 106, an electronic calendar of the meeting requestor is marked with an indicia of the attendance probability value for the potential attendee. After marking step 106 is completed, the method continues to determining step 108.

At determining step 108, the attendance probability value is compared to an attendance probability threshold. If the attendance probability value is beyond an attendance probability threshold, the process proceeds to scheduling step 110, where the proposed meeting is automatically scheduled. On the other hand, if the free-time probability value is not beyond the free-time probability value threshold, the process continues to suggestion step 112. At suggestion step 112, at least one alternative time interval in which the proposed meeting may be scheduled is proposed to the meeting requestor.

Crowd-sourcing may be performed to determine a likelihood of attending. For example, other people in a company may note that a person is not likely to attend under certain circumstances, and this information may be saved in a database. This feature may be an opt-in feature, so that if certain individuals do not wish to me monitored, privacy is maintained. The system may also allow for use of “elastic nets” to determine this probability in conjunction with crowd sourcing technology.

Note that crowd-sourcing technology may allow a crowd to adjust linkages between individuals and specific meetings. The linkage is established when a user accepts an invitation to a meeting. In this system, all acceptances may be treated as “tentative” and the level of commitment of the invitee to attend can be set initially, creating a weighted linkage between the invitee and to the meeting. This can be further adjusted by the invitee subsequent to his or her acceptance.

The meeting chair may also adjust a linkage from the meeting to the user, indicating the level of importance that a specific invitee attends. This then can be combined with the invitee's level of commitment by some function (linear or nonlinear). Others may also have access to this linkage parameter, for example, the invitees manager, or the manager of the meeting chair.

The set of all meetings and linkages can then be represented as a network. After all linkages are adjusted (for example, at the start of particular day, or before a subsequent meeting time slot), all linkages in the network joining all users and all meetings are then rendered as an “elastic net”. The role of the elastic net algorithm is to allow individuals and meetings to “move” relative to each other in the network based on the strength of linkages. After adjusting all meetings and users according to this algorithm, a partitioning algorithm can then be applied, assigning individuals to meetings based on their final proximity in the elastic net.

Note that the elastic net and partitioning algorithms can be implemented for each meeting time slot on an ongoing basis, to allow users to look ahead at their schedule based on the current setting for all linkage weights. The meetings they are likely to attend would be dynamically adjusted at some interval and their calendars would then be adjusted continually by this crowd-sourcing element, until a commitment time is reached, and the final partitioning occurs.

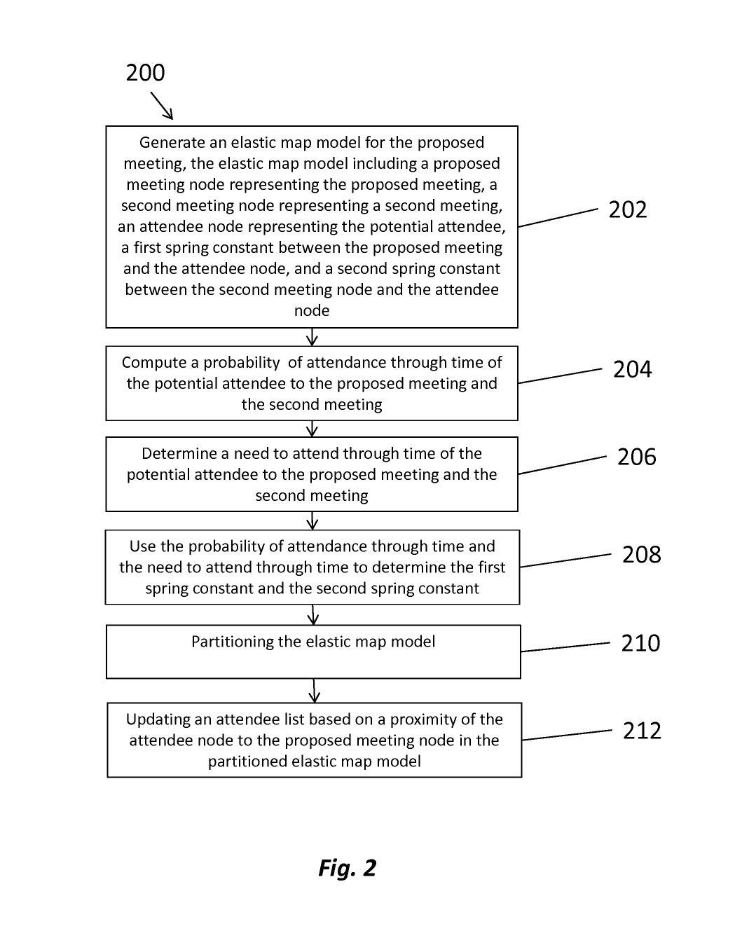

FIG. 2 shows an example method for calculating the attendance probability value using crowd sourcing according to one embodiment of the present invention. The method includes an elastic map generation step 202. During elastic map generation step 202, an elastic map model for the proposed meeting is generated. The elastic map model may include a proposed meeting node representing the proposed meeting, a second meeting node representing a second meeting, an attendee node representing the potential attendee, a first spring constant between the proposed meeting and the attendee node, and a second spring constant between the second meeting node in the attendee node. After elastic map generation step 202 is completed, the method continues to a probability computing step 204.

During the probability computing step 204, a probability of attendance through time of the potential attendee to the proposed meeting and the second meeting is computed. After the probability computing step 204 is completed, the method continues to need to attendance determination step 206.

During the attendance determination step 206, a need to attend through time of the potential attendee to the proposed meeting and the second meeting is determined. After the attendance determination step 206 is completed, the method continues to a spring constant determination step 208.

During the spring constant determination step 208, both the first spring constant and the second spring constant are determined using the probability of attendance through time and the need to attend through time. After the spring constant determination step 208 is completed, the method continues to an elastic map partitioning step 210.

During the elastic map partitioning step 210, the elastic map is partitioned. Following elastic map partitioning step 210, the method continues to an attendee list update step 212.

During the attendee list update step 212, an attendee list is updated based on a proximity of the attendee node to the proposed meeting node in the partitioned elastic map model.

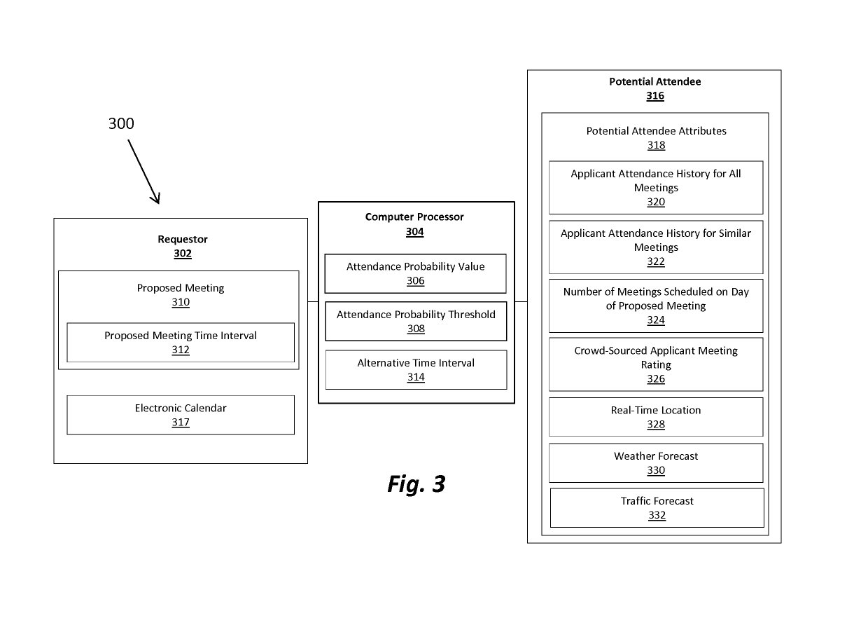

FIG. 3 shows a system for planning meeting attendance in accordance with one embodiment of the present invention. The system includes a computer processor 304, at least one meeting requestor 302, and at least one potential attendee 316.

In one embodiment, the computer processor 304 is configured to receive from the meeting requestor 302 a request to schedule a proposed meeting 310 at a proposed meeting time interval 312. In addition, the computer processor is configured to calculate an attendance probability value 306 for a potential attendee 316 based, at least in part, on the potential attendee's location over time. The computer processor is also configured to mark an electronic calendar 317 of the meeting requestor 302 with an indicia of the attendance probability value 306 for the potential attendee 316.

In another embodiment, the computer processor 304 is further configured to schedule the proposed meeting 310 if the attendance probability value 306 is beyond an attendance probability threshold 308.

In another embodiment, the computer processor 304 is further configured to automatically suggest to the meeting requestor 302 at least one alternative time interval 314 in which the proposed meeting 310 may be scheduled if the attendance probability value 306 is within the attendance probability threshold 308. The system may search for a time interval where an attendance probability value of a potential attendee exceeds the threshold attendance probability value in order to suggest at least one alternative time interval. For example, if the attendance probability threshold has a value of 0.6, the system may search for a time interval with an attendance probability value greater than 0.6. If the system identifies a time interval with an attendance probability value greater than 0.6, the system may suggest to the meeting requestor that time interval as an alternative time interval in which the proposed meeting may be scheduled.

In another embodiment, the attendance probability value 306 may be further based on at least one potential attendee attribute 318. The potential attendee attribute 318 may include an applicant history of attendance for all meetings 320, an applicant history of attendance for similar meetings 322, and/or a number of meetings scheduled on a calendar of the potential attendee on the day of the proposed meeting 324.

In another embodiment, the potential attendee attribute may include a crowd-sourced applicant meeting rating 326. The crowd-sourced applicant meeting rating includes a combined evaluation of subjective peer opinions of the potential attendee's likelihood of attending the proposed meeting.

As an example of crowd-sourced applicant meeting rating, when determining a potential attendee's attendance probability value, other meeting invitees may “rate” the potential attendee's likelihood of attending the proposed meeting. If the ratings from a number of invitees are high (e.g., indicating that the invitees feel that the potential attendee is likely to attend the meeting), then the crowd-sourced applicant meeting rating becomes high (e.g., it is likely that the potential attendee will attend the proposed meeting, because invitees have indicated that they subjectively feel the potential attendee will attend).

In another embodiment, the at least one potential attendee attribute 318 comprises a real-time location of the potential attendee prior to the time interval of the proposed meeting 328. Additionally, in another embodiment, the potential attendee attribute 318 further comprises at least one of a weather forecast 330 and a traffic forecast 332 at the real-time location of the potential attendee. For example, if a meeting is to be held in-person, the meeting is located in New York at 1:00 pm, and the potential attendee is in Florida at 12:30 pm, it is impossible that the potential attendee will attend the meeting in-person. It may also be unlikely, to varying degrees, that the person attend the meeting even using the phone. Additionally, if another potential attendee's real-time location reveals that she is ten miles from the 1:00 pm meeting at 12:30 pm and both the traffic and weather forecasts are clear, her likelihood of attending the meeting in-person may be considered high. However, if the weather forecast predicts severe weather arriving to the area at 12:30 pm or the traffic forecast predicts heavy volume at 12:30 pm, her likelihood of attending the meeting in-person may be considered low.

Note that with current calendaring systems, sometimes colors are used to indicate whether individuals have “booked” time that is unavailable for use or “open” time when a person is free for meetings. Thus, a person attempting to schedule a meeting may note a color red (a potential attendee is booked or his time is blocked) or green (a potential attendee is free). In contrast to this, an embodiment of the system allows for multiple shades of coloring (e.g. between red and green) based on the percentage likelihood that a potential attendee will attend a proposed meeting. The setting of colors may be configurable by the meeting requestor or a third party.

A potential attendee may have a low attendance probability if, for example, she rarely attends meetings, even though she says she will. This low past attendance record may be determined by many means, including: a tendency to usually reject invitations if meetings are of a certain kind (e.g. in person vs. teleconference), or if the person accepts invitations but rarely attends (e.g. as determined by a roll call).

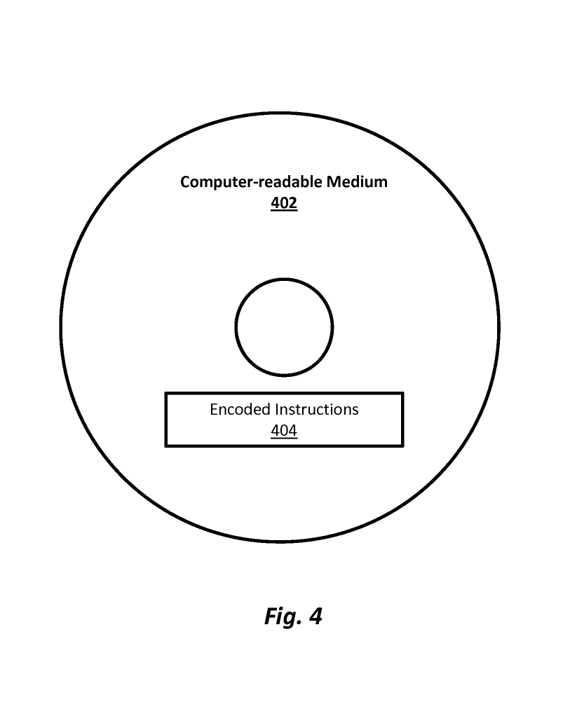

FIG. 4 shows a computer-readable medium 402 encoding instructions for performing a method for planning meeting attendance 404 according to one embodiment of the present invention.

One embodiment of the invention is a system for planning meeting attendance. The system comprising a computer processor configured to: receive from a meeting requestor a request to schedule a proposed meeting at a time interval; calculate an attendance probability value for a potential attendee based, at least in part, on the potential attendee's location over time; and marking an electronic calendar of the meeting requestor with an indicia of the attendance probability value for the potential attendee. The computer processor may be further configured to schedule the proposed meeting if the attendance probability value is beyond an attendance probability threshold. The computer processor further configured to suggest to the meeting requestor at least one alternative time interval in which the proposed meeting may be scheduled if the attendance probability value is within the attendance probability threshold. The attendance probability value for the potential attendee may be further based in part on at least one of the potential attendee's history of meeting attendance and a number of meetings scheduled on a calendar of the potential attendee on the day of the proposed meeting. The attendance probability value for the potential attendee may be further based in part on crowd-sourced applicant meeting attendance rating, the crowd-sourced applicant meeting attendance rating includes a combined evaluation of subjective peer opinions of the potential attendee's likelihood of attending the proposed meeting. The attendance probability value for the potential attendee may be further based in part on a real-time location of the potential attendee prior to the time interval of the proposed meeting. The attendance probability value for the potential attendee may be further based in part on at least one of a weather forecast and a traffic forecast at the real-time location of the potential attendee. Automatically calculating the attendance probability value may include: generating an elastic map model for the proposed meeting, the elastic map model including a proposed meeting node representing the proposed meeting, a second meeting node representing a second meeting, an attendee node representing the potential attendee, a first spring constant between the proposed meeting and the attendee node, and a second spring constant between the second meeting node and the attendee node; computing a probability of attendance through time of the potential attendee to the proposed meeting and the second meeting; determining a need to attend through time of the potential attendee to the proposed meeting and the second meeting; using the probability of attendance through time and the need to attend through time to determine the first spring constant and the second spring constant; partitioning the elastic map model; and updating an attendee list based on a proximity of the attendee node to the proposed meeting node in the partitioned elastic map model.

A further embodiment of the invention is a computer program product for planning meeting attendance. The computer program product comprising a computer readable storage medium having computer readable program code embodied therewith. The computer readable program code configured to: receive from a meeting requestor a request to schedule a proposed meeting at a time interval; calculate an attendance probability value for a potential attendee based, at least in part, on the potential attendee's location over time; and mark an electronic calendar of the meeting requestor with an indicia of the attendance probability value for the potential attendee. The computer readable program code may be configured to schedule the proposed meeting if the attendance probability value is beyond an attendance probability threshold. The computer readable program code may be configured to suggest to the meeting requestor at least one alternative time interval in which the proposed meeting may be scheduled if the attendance probability value is within the attendance probability threshold. The attendance probability value for the potential attendee may be further based in part on at least one of the potential attendee's history of meeting attendance and a number of meetings scheduled on a calendar of the potential attendee on the day of the proposed meeting. The attendance probability value for the potential attendee may be further based in part on a crowd-sourced applicant meeting attendance rating, the crowd-sourced applicant meeting attendance rating includes a combined evaluation of subjective peer opinions of the potential attendee's likelihood of attending the proposed meeting. The attendance probability value for the potential attendee may be further based in part on a real-time location of the potential attendee prior to the time interval of the proposed meeting. The attendance probability value for the potential attendee may be further based in part on at least one of a weather forecast and a traffic forecast at the real-time location of the potential attendee. Automatically calculating the attendance probability value may include: generating an elastic map model for the proposed meeting, the elastic map model including a proposed meeting node representing the proposed meeting, a second meeting node representing a second meeting, an attendee node representing the potential attendee, a first spring constant between the proposed meeting and the attendee node, and a second spring constant between the second meeting node and the attendee node; computing a probability of attendance through time of the potential attendee to the proposed meeting and the second meeting; determining a need to attend through time of the potential attendee to the proposed meeting and the second meeting; using the probability of attendance through time and the need to attend through time to determine the first spring constant and the second spring constant; partitioning the elastic map model; and updating an attendee list based on a proximity of the attendee node to the proposed meeting node in the partitioned elastic map model.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for planning meeting attendance, the method comprising:
receiving from a meeting requestor a request to schedule a proposed meeting at a time interval;
automatically calculating by a computer processor an attendance probability value for a potential attendee based, at least in part, on the potential attendee's location over time; and
marking an electronic calendar of the meeting requestor with an indicia of the attendance probability value for the potential attendee.

2. The method of claim 1, further comprising:
automatically scheduling the proposed meeting if the attendance probability value is beyond an attendance probability threshold.

3. The method of claim 1, further comprising:
automatically suggesting to the meeting requestor at least one alternative time interval in which the proposed meeting may be scheduled if the attendance probability value is within the attendance probability threshold.

4. The method of claim 1, wherein the attendance probability value for the potential attendee is further based in part on at least one of the potential attendee's history of meeting attendance and a number of meetings scheduled on a calendar of the potential attendee on the day of the proposed meeting.

5. The method of claim 1, wherein the attendance probability value for the potential attendee is further based in part on a crowd-sourced potential attendee meeting attendance rating, the crowd-sourced potential attendee meeting attendance rating includes a combined evaluation of subjective peer opinions of the potential attendee's likelihood of attending the proposed meeting.

6. The method of claim 1, wherein the attendance probability value for the potential attendee is further based in part on a real-time location of the potential attendee prior to the time interval of the proposed meeting.

7. The method of claim 6, wherein the attendance probability value for the potential attendee is further based in part on at least one of a weather forecast and a traffic forecast at the real-time location of the potential attendee.

8. The method of claim 1, wherein automatically calculating the attendance probability value includes:
generating an elastic map model for the proposed meeting, the elastic map model including a proposed meeting node representing the proposed meeting, a second meeting node representing a second meeting, an attendee node representing the potential attendee, a first spring constant between the proposed meeting and the attendee node, and a second spring constant between the second meeting node and the attendee node;
computing a probability of attendance through time of the potential attendee to the proposed meeting and the second meeting;
determining a need to attend through time of the potential attendee to the proposed meeting and the second meeting;
using the probability of attendance through time and the need to attend through time to determine the first spring constant and the second spring constant;
partitioning the elastic map model; and
updating an attendee list based on a proximity of the attendee node to the proposed meeting node in the partitioned elastic map model.
